(19) United States
(12) Patent Application Publication
(10) Pub. No.: US 2007/0181104 A1
(43) Pub. Date: Aug. 9, 2007

(54) Air/fuel conditioning

(75) Inventor: Paul Anthony Collins, Llandrindod Wells (GB)

Correspondence Address: Law Office of Ira S Dorman, Suite 200, 330 Roberts Street, East Hartford, CT, 06108, US

(73) Assignee: HYANOL LIMITED, POWYS (GB)

(21) Appl. No.: 10/590,302

(22) PCT Filed: Feb. 24, 2005
(86) PCT No.: PCT/GB05/00686

§ 371 Date: Aug. 23, 2006

(30) Foreign Application Priority Data
Feb. 26, 2004 (GB) 0404189.3

(51) Int. Cl. F02M 27/00; F02G 5/00

(52) U.S. Cl. 123/537; 123/557; 123/538

(57) ABSTRACT

Apparatus, and method, for conditioning air and fuel supplied to a combustor comprising means (5) for electrostatically charging air supplied to a combustor at a first polarity, means (12) for electrostatically charging fuel supplied to such combustor at opposite polarity to said first polarity, and means (15, 19; 20) for preheating such fuel.

The present invention relates to an apparatus and method for conditioning air and fuel supplied to a combustor.

The invention is particularly concerned with the conditioning of air and fuel supplied to internal combustion engines for automotive or other applications and may be most usefully applied where fuel and air are injected or inducted separately into the combustion chamber(s), as in the case of diesel, GCI (gasoline direct injection) and certain gas engines.

The invention may, however, be found more generally useful for aiding combustion, increasing efficiency and/or reducing harmful emissions from prime movers, burners, furnaces or other kinds of combustor.

Various systems have been proposed which purport to improve the performance of and/or reduce emissions from internal combustion engines by electrically charging or ionising the supplied air and/or fuel, for example as known from U.S. Pat. No. 4,071,004, U.S. Pat. No. 4,183,337, U.S. Pat. No. 4,308,844, U.S. Pat. No. 5,010,869 and U.S. Pat. No. 6,463,917.

The present invention seeks to provide an apparatus and method whereby such aims may be more readily achieved.

In one aspect the invention accordingly resides in apparatus for conditioning air and fuel supplied to a combustor, comprising:

means for electrostatically charging air supplied to a combustor, at a first polarity;

means for electrostatically charging fuel supplied to such combustor, at opposite polarity to said first polarity; and

means for preheating such fuel.

Preferably the apparatus is adapted to charge air at negative polarity and to charge fuel at positive polarity.

The charging means may in each case comprise one or more pointed electrodes adapted to be connected to electric power supply means and extending into a respective duct through which, in use, the air or fuel flows to the combustor.

An earthed electrode may also be provided within the respective duct upstream of the aforesaid pointed electrode(s) in the sense of the flow of air or fuel through the duct.

The fuel may be preheated by heat exchange with fluid heated by the combustor. Additionally, or alternatively, the fuel may be preheated by electrically powered means. When both are provided, the apparatus may further comprise control means adapted to operate the electrically powered heating means when the fluid heat exchange means are ineffective to preheat the fuel to a specified temperature (for example, when the combustor has not yet reached its normal working temperature).

The invention also resides in a combustor equipped with air and fuel conditioning apparatus as defined above.

The invention also resides in a method of conditioning air and fuel supplied to a combustor, comprising:

electrostatically charging such air at a first polarity;

electrostatically charging such fuel at opposite polarity to said first polarity; and

preheating such fuel.

These and other features of the present invention will now be more particularly described, by way of example, with reference to the accompanying schematic drawings in which:

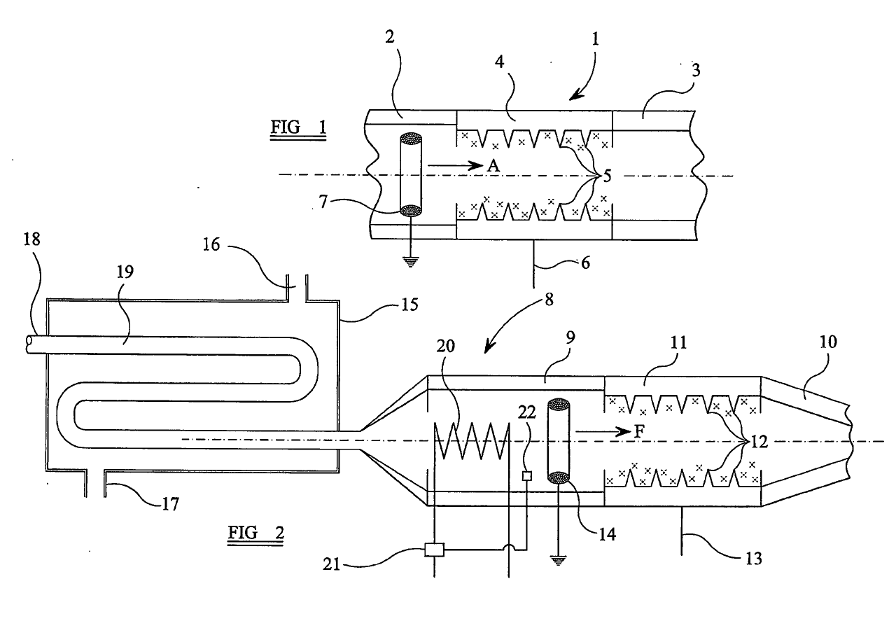

FIG. 1 is a section through the air conditioning unit in one embodiment of apparatus according to the invention; and

FIG. 2 is a section through the fuel conditioning unit of the apparatus.

The drawings illustrate examples of air and fuel conditioning units which may typically be used in conjunction with a diesel or other internal combustion engine.

The unit 1 illustrated in FIG. 1 is intended to be inserted in the air induction system of the engine, downstream of a filter and as close to the air inlets to the engine's combustion chambers as practicable.

It comprises a duct having an inlet section 2 and outlet section 3 both of dielectric material, through which air passes in the direction of the arrow ‘A’ on its way to the engine. Between the sections 2 and 3 there is a section of metal duct 4 formed with a plurality of pointed electrodes 5 extending into the interior of the duct.

A cable 6 connects the duct section 4 to a power supply (not shown) which applies a low-current high DC or pulsed voltage (typically of several kV to 1 MV) of negative polarity to each electrode 5.

The consequent surface electric field concentrated at the tip of each electrode results in corona discharges and the generation of negatively charged particles (ions) in the air flowing through the duct. This effect is enhanced by the presence of an earthed electrode, such as the ring electrode indicated at 7, within the duct adjacent to the electrodes 5 in the upstream direction, the natural direction of flow of the ions generated being away from this earth.

The unit 8 illustrated in FIG. 2 is intended to be inserted in the fuel line to the engine, preferably downstream of the fuel pump and as close to the fuel injectors to the engine's combustion chambers as practicable.

It comprises a duct having an inlet section 9 and outlet section 10 both of dielectric material, through which fuel passes in the direction of the arrow ‘F’ on its way to the engine. Between the sections 9 and 10 there is a section of metal duct 11 formed with a plurality of pointed electrodes 12 extending into the interior of the duct.

A cable 13 connects the duct section 11 to a power supply (not shown) which applies a low-current high DC or pulsed voltage (typically of several kV to 1 MV) of positive polarity to each electrode 12.

The consequent surface electric field concentrated at the tip of each electrode results in corona discharges and the generation of positively charged particles (ions) in the fuel flowing through the duct. This effect may be enhanced by the presence of an earthed electrode, such as the ring electrode indicated at 14, within the duct adjacent to the electrodes 12 in the upstream direction, the natural direction of flow of the ions generated being away from this earth.

In addition to conditioning the fuel by ionisation in this apparatus it is also preheated, and two separate means are illustrated in FIG. 2 for this purpose.

The first comprises a water jacket 15 through which hot water from the engine's cooling system is circulated, having an inlet 16 and an outlet 17. Fuel flows from an inlet 18 through a serpentine passageway 19 within the jacket 15, picking up heat from the water prior to its passage through the duct 9, 11, 10.

This will not be effective to heat the fuel until the engine has reached its normal working temperature, however, so to cater for the cold start condition an electrically powered fuel heater is also provided. This is illustrated schematically in FIG. 2 as an electrical heating element 20 within the duct section 9, controlled by a thermostat 21 in response to a fuel temperature sensor 22.

The fuel heating arrangement shown in FIG. 2 may be set up such that when starting the engine from cold the electric heater 20 is initially operative, and is switched off under thermostatic control when the engine has heated up and preheated fuel above a specified temperature begins to be delivered from the water heater 15.

In other embodiments, however, the water heater may be dispensed with and fuel preheating is accomplished solely by one or more electric heaters. In the case of diesel fuel, for example, it is believed that preheating to a temperature in the region of 200° C. may be beneficial, which could not readily be accomplished through use of engine coolant as the heat source.

In another variant, the separate earthed electrode 14 in the fuel conditioning unit may be functionally replaced by the casing of an electric heater such as 20.

Although not all the effects of air and fuel conditioning in an apparatus as exemplified above are fully understood at present, it is believed that applying electrical charges of like polarity to the fuel assists in the subsequent atomisation and dispersal of the fuel into finer droplets within the engine.

Preheating of the fuel is believed to facilitate the ionisation process and enhance particle break up. Furthermore by charging the air for combustion at the opposite polarity to the fuel, subsequent intermixing of the fuel and air should be more rapid and more complete. The consequences are that combustion can be initiated more reliably and the mixture can burn more completely, leading in turn to better fuel economy, higher power output and/or reduction in the amounts of unburnt hydrocarbon, carbon monoxide and particle emissions.

Lower exhaust temperatures and lower formation of oxides of nitrogen may also be realised.

1. Apparatus for conditioning air and fuel supplied to a combustor, comprising:
means (5) for electrostatically charging air supplied to a combustor, at a first polarity, the means extending into a first duct (2, 3, 4) through which, in use, air flows to the combustor;
means (12) for electrostatically charging fuel supplied to such combustor, at opposite polarity to said first polarity, the means extending into a second duct (9, 10, 1) through which, in use, fuel flows to the combustor;
means (15, 19, 20) for preheating such fuel; and
an earthed electrode (7, 14) within a duct selected from the first duct and the second duct.

2. Apparatus according to claim 1, wherein the apparatus is adapted to charge air at negative polarity and to charge fuel at positive polarity.

3. Apparatus according to claim 1, wherein said means for electrostatically charging air comprises one or more pointed electrodes (5) adapted to be connected to electronic power supply means and extending into the first duct (2, 3, 4).

4. Apparatus according to claim 3, wherein the earthed electrode (7) within the first duct (2, 3, 4) is upstream of said pointed electrode(s) (5) in the sense of flow of air through the first duct.

5. Apparatus according to claim 1, wherein said means for electrostatically charging fuel comprises one or more pointed electrodes (12) adapted to be connected to electric power supply means and extending into a the second duct (9, 10, 11).

6. Apparatus according to claim 5, wherein the earthed electrode (14) within the second duct (9, 10, 11) is upstream of said pointed electrode(s) (12) in the sense of flow of fuel through the second duct.

7. Apparatus according to claim 1, wherein said preheating means (15, 19, 20) are located upstream of said means (12) for electrostatically charging fuel in the sense of flow of fuel to the combustor.

8. Apparatus according to claim 1, wherein said preheating means comprise means (15, 19) for preheating such fuel by heat exchange with fluid heated by the combustor.

9. Apparatus according to claim 1, wherein said preheating means comprise electrically powered heating means (20).

10. Apparatus according to claim 9, wherein said electrically powered heating means comprise an element (20) disposed within the duct (9, 10, 11) through which, in use, fuel flows to the combustor which serves also as said earthed electrode (14).

11. Apparatus according to claim 8, wherein control means (21, 22) is provided adapted to operate said electrically powered heating means (20) when said fluid heat exchange means (15, 19) are ineffective to preheat such fuel to a specified temperature.

12. A combustor equipped with apparatus according to claim 1 for conditioning air and fuel supplied to the same.

13. A combustor according to claim 12 in the form of an internal combustion engine.

14. A method of conditioning air and fuel supplied to a combustor, comprising the steps of:
electrostatically charging such air at a first polarity within a first duct (2, 3, 4) through which, in use, air flows to the combustor;
electrostatically charging such fuel at opposite polarity to said first polarity within a second duct (9, 10, 11) through which, in use, fuel flows to the combustor;
providing an earthed electrode (7, 14) within a duct selected from the first duct and the second duct; and
preheating such fuel.

15. (canceled)
